(19) United States
(12) Patent Application Publication
(10) Pub. No.: US 2004/0193751 A1
(43) Pub. Date: Sep. 30, 2004

(54) System and method for providing fee-based data services

(76) Inventors: Harpreet Singh, Orange, CA (US); Marianne Kodimer, Huntington Beach, CA (US); Mustafa Seifi, Irvine, CA (US); Kenneth Stephenson, San Clemente, CA (US)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/816,653

(22) Filed: Apr. 2, 2004

Related U.S. Application Data
(63) Continuation-in-part of application No. 10/746,530, filed on Dec. 24, 2003.
(60) Provisional application No. 60/437,644, filed on Jan. 2, 2003.

(51) Int. Cl. G06F 3/00

(52) U.S. Cl. 710/15

(57) ABSTRACT

A system and method to allow users in a non-office environment to access and use data services, such as scanning, printing, and distribution of documents and data and to charge the users for such services. Multifunctional peripheral devices are provided to service location providers for use by mobile users. A multifunctional peripheral device provider sells or leases the multifunctional peripheral device, related hardware and software, parts, and supplies to service location providers. The service location provider then provides access to the multifunction peripheral device and related services to mobile users. The user is then charged for the services used. The fees are paid to the multifunctional peripheral device provider. At least a portion of these fees are paid to any dealers involved in the sale or lease of the multifunctional peripheral device and to the service location providers. Any fees related to the sale or installation of the multifunctional peripheral device is also paid to the multifunctional peripheral device provider. At least a portion of these fees is paid to any dealers involved in the sale or lease of the multifunctional peripheral device.

### CROSS-REFERENCE TO RELATED APPLICATIONS

The present application is a continuation-in-part of U.S. application Ser. No. 10/746,530 filed Dec. 24, 2003, which claims the benefit of U.S. Provisional Application 60/437,644, filed Jan. 02, 2003.

### BACKGROUND OF THE INVENTION

This invention is directed to a system and method for providing fee-based data services. More particular, this invention is directed to a system and method to allow users in a non-office environment to access and use data services for secure temporary storage and distribution of data, and to charge the users for such services.

Typically, professionals routinely work with documents or other data while away from their office environment. These professionals need to generate image data, by scanning a document, and then to need to distribute or perform other functions on such image data. Multifunctional peripheral devices, such as printers and scanning devices, routinely perform such operations. However, if the image data the user desires to distribute is very large, the user will typically be unable to send such image file as an attachment to an electronic mail message. In such instance, the user will have to place the image file in a repository on the multifunctional peripheral device which is accessible to the desired recipients and the recipients will have to obtain the image data from such repository. The repository on a multifunctional peripheral device in a public facility is typically not secure and image data stored in the repository is accessible by the general public.

There is a need for system and method to provide fee-based data services for secure temporary storage and distribution of image data to users in a non-office environment.

### SUMMARY OF THE INVENTION

In accordance with the present invention, there is provided a system and method for providing fee-based data services secure temporary storage and distribution of image data to user in a non-office environment.

Further, in accordance with the present invention, there is provided a system and method to allow users in a non-office environment to access and use data services for secure temporary storage and distribution of data, and to charge the users for such services.

Still further in accordance with the present invention, there is provided a system for providing fee-based access to shared data peripheral devices. The system comprises a data peripheral system comprising at least one data input/output device and a secure data storage medium. The system also comprises allocation means adapted to allocate a selected storage area in the secure data storage medium and data communication means adapted for communicating data from the at least one data input/output device into the selected storage area of secure data storage medium. The system further includes accounting means adapted for securing charge information from an associated user, which charge information allows for securing of payment for use of the data peripheral system, verification means adapted for securing charge verification information corresponding to charge information received from the associated user, and enabling means adapted for enabling operation of the data peripheral system in accordance with an output of the verification means so as to provide fee-based access of the associated user to the peripheral system.

In a preferred embodiment, the system includes means adapted for storing an access control list, which access control list dictates an identity of users authorized to access data stored in the selected storage area of the secure data storage medium. Preferably, the system also includes means adapted for selectively de-allocating the selected storage area in the secure data storage medium after expiration of a preselected duration.

Still further, in accordance with the present invention, there is provided a method for providing fee-based access to shared data peripheral devices. The method comprises the steps of allocating a selected storage area in a secure data storage medium, communicating data from at least one data input/output device in a data peripheral system into the selected storage area of secure data storage medium, and securing charge information from an associated user, which charge information allows for securing of payment for use the data peripheral system. The method also comprises the steps of securing charge verification information corresponding to charge information received from the associated user and enabling operation of the data peripheral system in accordance with an output of the verification means so as to provide fee-based access of the associated user to the peripheral system.

In a preferred embodiment, the method includes the step of storing an access control list, which access control list dictates an identity of users authorized to access data stored in the selected storage area of the secure data storage medium. Preferably, the method further includes the step of selectively de-allocating the selected storage area in the secure data storage medium after expiration of a preselected duration.

These and other advantages, aspects, and features will be understood by one of ordinary skill in the art upon reading and understanding the specification.

### BRIEF DESCRIPTION OF THE DRAWINGS

FIG. 1 is a diagram illustrating a system for providing fee-based data services to users in a non-office environment according to the present invention.

FIG. 2 is a sample template for selecting the parameters for storing and distributing the image data.

FIG. 3 is flowchart of one embodiment for providing fee-based data services to users in a non-office environment according to the present invention.

### DETAILED DESCRIPTION OF THE PREFERRED EMBODIMENTS

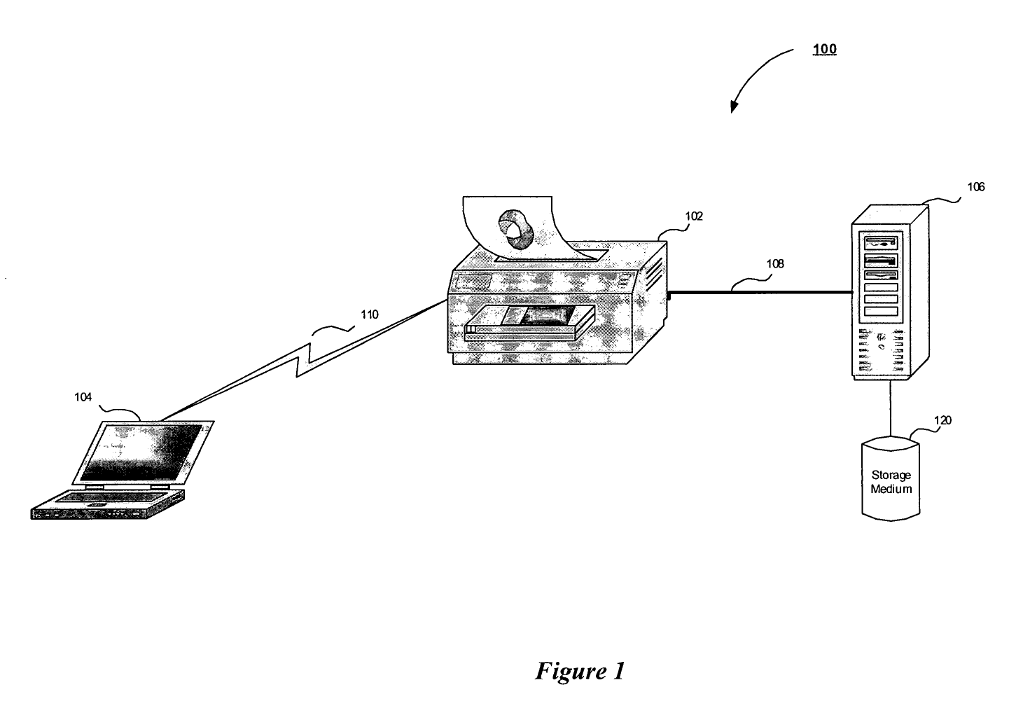

The present invention is directed to a system and method for providing fee-based data services to mobile users. A diagram illustrating the system 100 is shown in FIG. 1. In the present invention, a mobile user is provided access to a multifunctional peripheral device 102 in a non-office environment, such as an airport lounge or business center. Other non-office environment locations include, but limited to, university campuses, conference centers, libraries, and hotels. The user accesses the multifunctional peripheral device 102 directly or via a computer or other suitable interface 104 via a suitable communication link 110. The multifunctional peripheral is connected to an associated central server 106 via a suitable communication link 108, such as the Internet. The central server includes an associated secure storage medium 112 for storing image data generated by the user. The user is then provided with information about the services available to be performed. The information is provided in any suitable manner known in the art. The information is suitably provided by way of a user interface associated with the multifunctional peripheral device or documentation provided related thereto.

The services provided to the user are those typically provided by multifunctional peripheral devices and associated software. In this invention, the system allows the user to generate image data, such as by scanning a document, and then to store the image data in secure storage medium 112 for a predetermined time. The image data stored in the secure temporary storage is accessible by those persons authorized by the user.

The user is then provided with information about the available payment options for paying for the desired services. The payment options include any suitable payment options known in the art for charging for mobile fee-based services. Suitable payment options include, but are not limited to, credit cards, prepaid accounts, coupons, and partner accounts. These payment options can be suitably group accounts and individual accounts. The user then selects the desired payment option from the options provided. The requirements for paying the fees depend on the payment option selected. If the user selects the credit card option, the user is prompted to provide selected information about the user's credit card, such as credit card type, credit card number, the credit card holder's name, and the expiration date. The information is suitably provided by the user by any suitable means known in the art. Examples of such input are by direct user input via a keyboard interface or the like, or by access to a pre-stored information on a memory device, such as a magnetic strip, embedded data storage or an intelligent card. The information is then sent to the central server via the communication link for authentication and approval from the credit card company shown as 108. Such information is provided by the central server to the credit card company by any suitable method known in the art. Given that sensitive information is being transmitted, a suitable security encryption or authentication system, as will be readily appreciated by one of ordinary skill in the art, is advantageously used. The authentication of the information and the transaction approval is provided by any suitable method known in the art. Preferably, the user is informed of the status of the approval. Preferably, if the transaction is not approved, the user is requested to submit information for an alternative credit card. In one embodiment, the user's credit card is charged for every transaction at the time of the transaction. In another embodiment, the user's credit card is charged for the transactions monthly or other suitable periodic interval.

If the user selects the prepaid account option, the user is prompted to open a prepaid account by a suitable method known in the art. Preferably, the user is prompted to open the prepaid account via a web-enabled user interface at specified URL that is served by the central server. The user provides selected information about a credit card or other type of debit card to open the account. Upon authentication of the information and approval of the use of the credit card by any suitable means, the user is issued an account identification and associated password for the account. Information about the account is maintained in any suitable database or repository, preferably, on the central server. In one embodiment, the balance maintained in the user account is debited every time the user accesses services on the system. In another embodiment, the balance is debited every month or other suitable periodic interval. The user may replenish the account by any suitable means at any time.

If the user selects the coupon option, the user is prompted to provide selected information about the coupons, such as the coupon issuer and the coupon number. This information is sent to the central server by any suitable means known in the art. The authentication of the information and the transaction approval is provided by any suitable method known in the art. Preferably, the user is informed of the status of the approval. Preferably, if the transaction is not approved, the user is requested to correct the information or provide alternative information. Preferably, the user is provided information about any applicable limits or restrictions on services associated with the use of the coupons, such as the number of pages printed.

If the user selects the partner account option, the user is prompted to selected a third party account provider from a list of available options by any suitable means. Examples of partner accounts, include, but are not limited to, Sprint PCS, AOL, Liberty Alliance, MS Passport, and AT&T. The user is prompted to provide selected information about the account, such as the account or user identification, and password. The information is provided to the central server by any suitable means known in the art. Such information is provided by the central server to the partner company by any suitable method known in the art. The authentication of the information and the transaction approval is provided by any suitable method known in the art. Preferably, the user is informed of the status of the approval. Preferably, if the transaction is not approved, the user is requested to correct the information or provide alternative information. In one embodiment, the user's account is charged for every transaction at the time of the transaction. In another embodiment, the user's account is charged for the transactions monthly or other suitable periodic interval. After selecting the desired payment option, the user is prompted to provide selected information about the desired service to be performed.

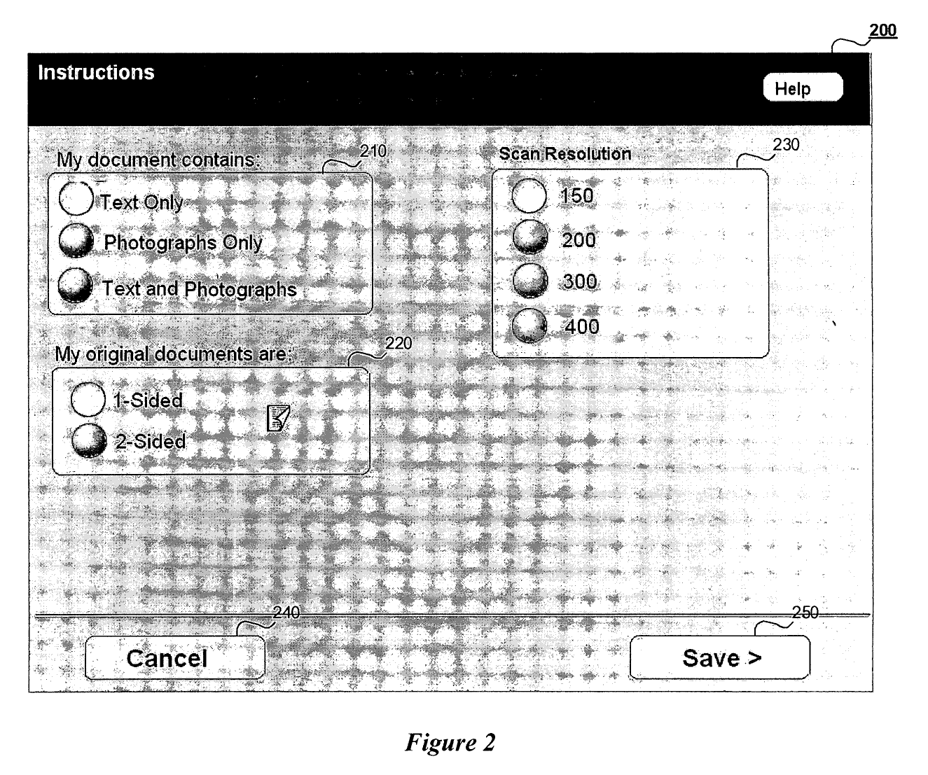

The user is then prompted to select the desired parameters for generating and storing the image data. For example, if the user is scanning a document, the user suitably provides information about the type of scan job, color, number of pages, image resolution and related information. The user also provides information relating to the storage parameters, such as the duration of the storage, information about the persons authorized to access the data, and other required information. FIG. 2 is a sample template 200 for selecting the parameters for generating the image data and the storage and access parameters.

As shown in FIG. 2, the template 200 screen prompts a user to select the type of document to be scanned by selecting one of the types in box 210. The types include text only, picture only or a combination of text and pictures. After selecting the type of document to be scanned, the user then instructs the system as to the layout of the original document. In box 220, the user selects either one-sided originals or two-sided originals. The scan resolution, that is dots-per-inch or dpi, is selected by the user in box 230. It will be appreciated by the skilled artisan that a higher resolution, when selected, will result in a larger corresponding digital image. The template 200 also enables the user to cancel the scan operation by clicking the cancel button 240, thereby terminating the operation and removing all selected parameters. Once the selected parameters are determined to be acceptable, the user then clicks the save button 250, enabling the scanning to proceed under the parameters selected by the user.

After receiving such information, the system starts generating the image data. The system assigns a temporary storage location on the secure storage medium for storing the image data via any suitable means. The image data is then stored in such temporary storage location. The system assigns a user identification and associated password to the user via any suitable means. The user must enter the user identification and password via any suitable means in order to access the image data in the secure storage medium. The authentication of the information and the approval is provided by any suitable method known in the art. Preferably, the user is informed of the status of the approval. Preferably, if the request to access the image data is not approved, the user is requested to correct the information or provide alternative information.

The system also assigns a user identification and associated password to each authorized person. This information is transmitted to the authorized persons via any suitable means, such as electronic mail messages. The authorized persons must enter the user identification and password via any suitable means in order to access the image data in the secure storage medium. The authentication of the information and the approval is provided by any suitable method known in the art. Preferably, the authorized person is informed of the status of the approval. Preferably, if the request to access the image data is not approved, the authorized person is requested to correct the information or provide alternative information.

Preferably, after generating and storing the image data, the system provides the user with the total cost associated with the selected services. For example, the costs are suitably based on the number of pages and image generating attributes, such as resolution, color, and file format. It is understood however, that the total cost associated with the selected services may be provided to the user prior to generating and storing the image data. Once the user has accepted the services by any suitable means known in the art, the services are performed. Preferably, the system provides a report of the status of the services to the user. Preferably, the user can view the results and make any needed changes to the services if the results are not acceptable. Information relating to the services is stored an associated repository, preferably located on the central server. The user is then billed for the services performed depending on the payment option selected by any suitable means known in the art. Preferably, a receipt is provided to the user upon completion of the services desired.

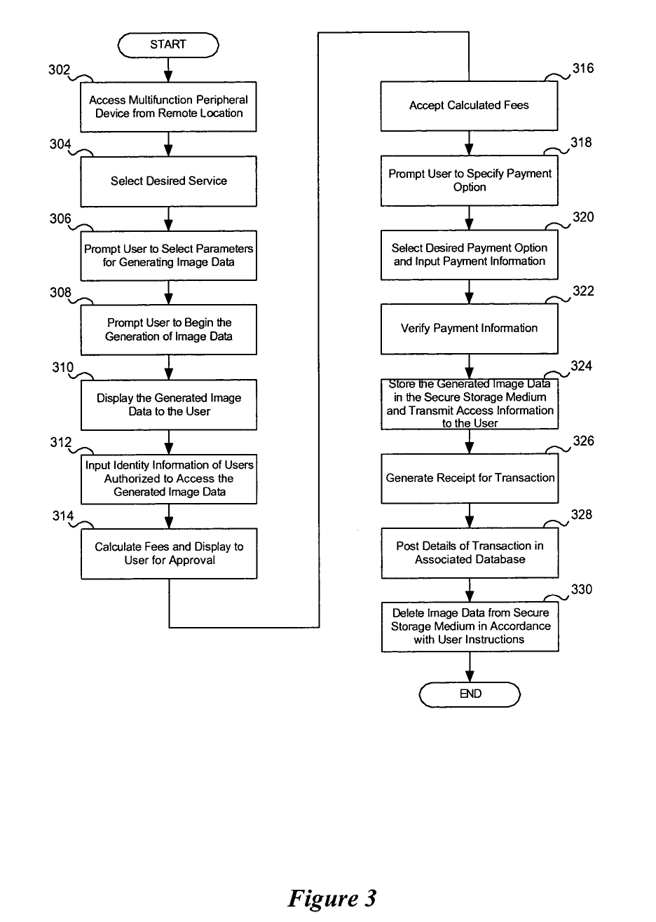

FIG. 3 shows a flowchart for providing fee-based data services to users in a non-office environment according to the present invention. As shown at 302, a user is provided access to a multifunctional peripheral device 102 in a non-office environment, such as an airport lounge or business center. The user accesses the multifunctional peripheral device via any suitable means, such as via a user interface associated with the multifunctional peripheral device. The user is presented with a description of the service to store or archive storage medium based files on an associated repository and the available payment options. At 304, the user selects the desired service via any suitable means.

At 306, the user is prompted via any suitable means to select the parameters for generating the image data. At 308, the user is prompted via any suitable means to start generating the image data.

At 310, the user is shown via any suitable means the generated image data. At 312, the user provides the identity information, such as electronic mail address, of those persons authorized to access the image data via any suitable means.

At 314, the system calculates the appropriate charges via any suitable means and presents the charges to the user via any suitable means for user approval. At 316, the user accepts the transaction via any suitable means. At 318, the user is prompted to specify a payment option via any suitable means and to provide the necessary information for the associated payment option.

At 320, the user selects the desired payment option via any suitable means and provides the information required to effectuate such payment via any suitable means. At 322, the system verifies the payment information received from the user. Upon verification of the payment information as shown at 324, the system stores the files or data in the secure storage medium and transmits the access information to the user and the authorized persons via any suitable means. Preferably, the access information is transmitted to the user and the authorized persons via electronic mail.

At 326, a receipt for the transaction is generated by the multifunctional peripheral device. The details of the transaction are posted in an associated database via any suitable means for later retrieval as shown at 328. At 330, the image data stored in the secure storage medium is deleted via any suitable means in accordance with the instructions provided by the user.

Although the preferred embodiment has been described in detail, it should be understood that various changes, substitutions, and alterations can be made therein without departing from the spirit and scope of the invention as defined by the appended claims. It will be appreciated that various changes in the details, materials and arrangements of parts, which have been herein described and illustrated in order to explain the nature of the invention, may be made by those skilled in the area within the principle and scope of the invention.

What is claimed is:

1. A system for providing fee-based access to shared data peripheral devices comprising:
a data peripheral system comprising at least one data input/output device;
a secure data storage medium;
allocation means adapted to allocate a selected storage area in the secure data storage medium;
data communication means adapted for communicating data from the at least one data input/output device into the selected storage area of secure data storage medium;
accounting means adapted for securing charge information from an associated user, which charge information allows for securing of payment for use of the data peripheral system;
verification means adapted for securing charge verification information corresponding to charge information received from the associated user; and
enabling means adapted for enabling operation of the data peripheral system in accordance with an output of the verification means so as to provide fee-based access of the associated user to the peripheral system.

2. The system for providing fee-based access to shared data peripheral devices of claim 1 further comprising means adapted for storing an access control list, which access control list dictates an identity of users authorized to access data stored in the selected storage area of the secure data storage medium.

3. The system for providing fee-based access to shared data peripheral devices of claim 1 further comprising means adapted for selectively de-allocating the selected storage area in the secure data storage medium after expiration of a preselected duration.

4. The system for providing fee-based access to shared data peripheral devices of claim 1 wherein the data peripheral system includes at least one of a printer, facsimile, scanning device, character recognition system, and storage device.

5. The system for providing fee-based access to shared data peripheral devices of claim 1 further comprising means adapted for selecting parameters for a selected data processing operation undertaken in connection with the data stored in the secure data storage medium.

6. The system for providing fee-based access to shared data peripheral devices of claim 1 wherein the charge information includes information associated with at least one of a pre-paid debit card, coupon, and credit card.

7. The system for providing fee-based access to shared data peripheral devices of claim 1 further comprising tracking means adapted for tracking the user's usage of the data peripheral system and cost generating means adapted for receiving an output from the tracking means and generating a cost for the user's usage of the data peripheral system.

8. The system for providing fee-based access to shared data peripheral devices of claim 7 further comprising billing means adapted for receiving an output from the cost generating means and applying the output to the user's charge information.

9. A method for providing fee-based access to shared data peripheral devices comprising the steps of:
allocating a selected storage area in a secure data storage medium;
communicating data from at least one data input/output device in a data peripheral system into the selected storage area of secure data storage medium;
securing charge information from an associated user, which charge information allows for securing of payment for use the data peripheral system;
securing charge verification information corresponding to charge information received from the associated user; and
enabling operation of the data peripheral system in accordance with an output of the verification means so as to provide fee-based access of the associated user to the peripheral system.

10. The method for providing fee-based access to shared data peripheral devices of claim 9 further comprising the step of storing an access control list, which access control list dictates an identity of users authorized to access data stored in the selected storage area of the secure data storage medium.

11. The method for providing fee-based access to shared data peripheral devices of claim 9 further comprising the step of selectively de-allocating the selected storage area in the secure data storage medium after expiration of a preselected duration.

12. The method for providing fee-based access to shared data peripheral devices of claim 9 wherein the data peripheral system includes at least one of a printer, facsimile, scanning device, character recognition system, and storage device.

13. The method for providing fee-based access to shared data peripheral devices of claim 9 further comprising the step of selecting parameters for a selected data processing operation undertaken in connection with the data stored in the secure data storage medium.

14. The method for providing fee-based access to shared data peripheral devices of claim 9 wherein the charge information includes information associated with at least one of a pre-paid debit card, coupon, and credit card.

15. The method for providing fee-based access to shared data peripheral devices of claim 9 further comprising the step of tracking the user's usage of the data peripheral system and generating a cost for the user's usage of the data peripheral system.

16. The method for providing fee-based access to shared data peripheral devices of claim 15 further comprising the step of applying the generated cost to the user's charge information.

17. A computer-readable medium for providing fee-based access to shared data peripheral devices comprising:
a data peripheral system comprising at least one data input/output device;
a secure data storage medium;
allocation means adapted to allocate a selected storage area in the secure data storage medium;
data communication means adapted for communicating data from the at least one data input/output device into the selected storage area of secure data storage medium;
accounting means adapted for securing charge information from an associated user, which charge information allows for securing of payment for use of the data peripheral system;
verification means adapted for securing charge verification information corresponding to charge information received from the associated user; and
enabling means adapted for enabling operation of the data peripheral system in accordance with an output of the verification means so as to provide fee-based access of the associated user to the peripheral system.

18. The computer-readable medium for providing fee-based access to shared data peripheral devices of claim 17 further comprising means adapted for storing an access control list, which access control list dictates an identity of users authorized to access data stored in the selected storage area of the secure data storage medium.

19. The computer-readable medium for providing fee-based access to shared data peripheral devices of claim 17 further comprising means adapted for selectively de-allocating the selected storage area in the secure data storage medium after expiration of a preselected duration.

20. The computer-readable medium for providing fee-based access to shared data peripheral devices of claim 17 wherein the charge information includes information associated with at least one of a pre-paid debit card, coupon, and credit card.

21. The computer-readable medium for providing fee-based access to shared data peripheral devices of claim 17 further comprising tracking means adapted for tracking the user's usage of the data peripheral system and cost generating means adapted for receiving an output from the tracking means and generating a cost for the user's usage of the data peripheral system.

22. The computer-readable medium for providing fee-based access to shared data peripheral devices of claim 21 further comprising billing means adapted for receiving an output from the cost generating means and applying the output to the user's charge information.

23. A computer-implemented method for providing fee-based access to shared data peripheral devices comprising the steps of:
allocating a selected storage area in a secure data storage medium;
communicating data from at least one data input/output device in a data peripheral system into the selected storage area of secure data storage medium;
securing charge information from an associated user, which charge information allows for securing of payment for use the data peripheral system;
securing charge verification information corresponding to charge information received from the associated user; and
enabling operation of the data peripheral system in accordance with an output of the verification means so as to provide fee-based access of the associated user to the peripheral system.

24. The computer-implemented method for providing fee-based access to shared data peripheral devices of claim 23 further comprising the step of storing an access control list, which access control list dictates an identity of users authorized to access data stored in the selected storage area of the secure data storage medium.

25. The computer-implemented method for providing fee-based access to shared data peripheral devices of claim 23 further comprising the step of selectively de-allocating the selected storage area in the secure data storage medium after expiration of a preselected duration.

26. The computer-implemented method for providing fee-based access to shared data peripheral devices of claim 23 wherein the charge information includes information associated with at least one of a pre-paid debit card, coupon, and credit card.

27. The computer-implemented method for providing fee-based access to shared data peripheral devices of claim 23 further comprising the step of tracking the user's usage of the data peripheral system and generating a cost for the user's usage of the data peripheral system.

28. The computer-implemented method for providing fee-based access to shared data peripheral devices of claim 27 further comprising the step of applying the generated cost to the user's charge information.
